(19) United States
(12) Patent Application Publication
(10) Pub. No.: US 2026/0163119 A1
(43) Pub. Date: Jun. 11, 2026

(54) BATTERY CYCLING SYSTEM CONFIGURED TO HEAT AND COOL BATTERY

(71) Applicant: GM GLOBAL TECHNOLOGY OPERATIONS LLC, Detroit, MI (US)

(72) Inventors: Hernando GONZALEZ MALABET, Livonia, MI (US); Artem BASKIN, Rochester Hills, MI (US); Erik Brandon GOLM, Sterling Heights, MI (US); Nathan THOMPSON, Sterling Heights, MI (US)

(21) Appl. No.: 18/974,725

(22) Filed: Dec. 9, 2024

(51) Int. Cl. H01M 10/6572; H01M 10/04; H01M 10/42; H01M 10/44; H01M 10/46; H01M 10/48; H01M 10/613; H01M 10/615; H01M 10/635; H01M 10/6571; H01M 50/103; H01M 50/105; H01M 50/109

(52) U.S. Cl. CPC H01M 10/6572; H01M 10/0481; H01M 10/4285; H01M 10/44; H01M 10/46; H01M 10/486; H01M 10/613; H01M 10/615; H01M 10/635; H01M 10/6571; H01M 50/103; H01M 50/105; H01M 50/109

(57) ABSTRACT

A battery cycling system including: a base configured to support a battery cell in cooperation with lead lines for cycling the battery cell; a heating device configured to heat the battery cell during cycling of the battery cell; a cooling device configured to cool the battery cell during cycling of the battery cell, the cooling device movable between an inactive position in which the cooling device is spaced apart from the battery cell and an active position in which the cooling device is in contact with the battery cell to cool the battery cell; and an actuator configured to move the cooling device from the inactive position to the active position to cool the battery cell during cycling of the battery cell.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cycling systems and methods that heat and cool a battery cell during charge and discharge cycling.

Battery cells supply voltage for a variety of different applications. With respect to the automotive industry, for example, battery cells are used to power motors of fully electric vehicles and hybrid vehicles. Battery cell development includes cycling battery cells through multiple charge cycles and discharge cycles, and studying various thermochemical reactions that take place during the cycling.

### SUMMARY

The present disclosure provides for, in various features, a battery cycling system including: a base configured to support a battery cell in cooperation with lead lines for cycling the battery cell; a heating device configured to heat the battery cell during cycling of the battery cell; a cooling device configured to cool the battery cell during cycling of the battery cell, the cooling device movable between an inactive position in which the cooling device is spaced apart from the battery cell and an active position in which the cooling device is in contact with the battery cell to cool the battery cell; and an actuator configured to move the cooling device from the inactive position to the active position to cool the battery cell during cycling of the battery cell.

In further features, the battery cell is one of a coin cell, a pouch cell, and a prismatic cell.

In further features, a battery holder is configured to hold the battery cell. The heating device includes a resistance heater beneath the battery holder.

In further features, the cooling device includes a thermoelectric cooling device.

In further features, the cooling device includes a Peltier cooling device attached to a heat sink with a thermal paste.

In further features, the cooling device includes a thermoelectric cooler and at least one of a fan, a heat sink, and a liquid cooling device.

In further features, the cooling device is included with a cooling assembly supported over the base, the cooling assembly movable to and away from the base and the battery cell seated on the base, the cooling assembly further including a fan and a heat sink.

In further features, the cooling assembly including the cooling device is biased in the inactive position, which is a raised position.

In further features, the actuator includes a lever movable to press the cooling assembly down onto the battery cell and press a thermoelectric cooler of the cooling device into direct physical contact with the battery cell.

In further features, the lever is configured to be hand-operated.

In further features, a temperature sensor is configured to sense temperature of the battery cell during cycling of the battery cell.

In further features, the battery cycling system includes a battery cycler configured to run the battery cell through charge cycles and discharge cycles; and a controller configured to operate the heating device and the cooling device to heat and cool the battery cell during the charge cycles and the discharge cycles based on inputs from the temperature sensor.

In further features, each one of the heating device, the cooling device, and the actuator is mounted directly to or indirectly to the base.

The present disclosure further includes, in various features, a battery cycling system including: a battery holder configured to hold a battery cell, the battery holder including contacts configured to cooperate with lead lines for cycling the battery cell; a resistance heater beneath the battery holder configured to heat the battery cell seated in the battery holder during cycling of the battery cell; a cooling assembly including a thermoelectric cooler, a fan, and a heat sink, the cooling assembly mounted over the battery holder and movable between an active position and an inactive position; and an actuator configured to move the cooling assembly from an inactive position in which the thermoelectric cooler is spaced apart from the battery cell and an active position in which the thermoelectric cooler is in direct contact with the battery cell to cool the battery cell during cycling of the battery cell.

In further features, the actuator includes a lever movable to press the cooling assembly down onto the battery holder and press the thermoelectric cooler into direct physical contact with the battery cell.

In further features, a temperature sensor is configured to sense temperature of the battery cell during cycling of the battery cell.

In further features, a battery cycler is configured to run the battery cell through charge cycles and discharge cycles; and a controller is configured to operate the resistance heater and the cooling assembly to heat and cool the battery cell during the charge cycles and the discharge cycles.

The present disclosure further includes, in various features, a battery cycling method including: charging a battery cell in contact with electrical conductors for cycling the battery cell; discharging the battery cell; during at least one of the charging and the discharging of the battery cell, heating the battery cell with a heating device; and during at least one of the charging and the discharging of the battery cell, moving a cooling assembly from an inactive position in which a thermoelectric cooler of the cooling assembly is spaced apart from the battery cell to an active position in which the thermoelectric cooler is in direct physical contact with the battery cell to cool the battery cell, the cooling assembly further including a fan and a heat sink.

In further features, moving the cooling assembly includes moving a lever to press the cooling assembly down and press the thermoelectric cooler into direct physical contact with the battery cell.

In further features, the battery cell is one of a coin cell, a pouch cell, and a prismatic cell.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an exemplary battery cycling system in accordance with the present disclosure in an inactive cooling configuration;

FIG. 2 is a side view of the battery cycling system of FIG. 1,

FIG. 3 is a cross-sectional view taken along line 3-3 of FIG. 2;

FIG. 4 is a cross-sectional view taken along line 4-4 of FIG. 2;

FIG. 5 is a perspective view of the battery cycling system of FIG. 1 in an active cooling configuration; and

FIG. 6 is a side view of the battery cycling system of FIG. 1 configured without a battery cell holder.

In the drawings, reference numbers may be reused to identify similar and/or identical elements.

### DETAILED DESCRIPTION

The present disclosure is directed to battery cycling systems and methods that heat and cool battery cells during cycling. The systems and methods facilitate, for example, observation of thermal electrochemical reactions taking place in battery cells during charging and discharging. The systems and methods of the present disclosure provide temperature profile stabilization for fast-charging battery cycling experiments. The ability to observe electrochemical reactions of battery cells during charging and discharging is useful during battery cell research, design, and development, for example. Thermochemical responses of various battery material combinations may be observed using the battery cycling systems and methods of the present disclosure.

The battery cycling systems and methods of the present disclosure are configured for cycling any suitable battery cells configured for any suitable use. For example, the battery cycling systems and methods are configured to cycle battery cells designed to power motors of fully electric vehicles, hybrid vehicles, etc. The battery cycling systems and methods are configured to cycle battery cells designed for any other suitable use as well.

The battery cycling systems and methods of the present disclosure are configured to apply heat-cool pulses (HCP) to a battery cell to resolve or identify all thermal electrochemical reactions. The systems and methods of the present disclosure enable cooling rates of, for example, 40° C./min and reach temperatures as low as 3.5° C. (or potentially lower in some applications if appropriate). The cooling time takes about 2% of the charging sweep time (1° C. rate). The systems and methods of the present disclosure are configured to rapidly remove heat from (and thus cool) a battery cell being studied by moving a thermoelectric cooling device into direct physical contact with the battery cell.

The battery cycling systems and methods described herein may be configured as portable bench-top devices, which may be hand operated. The systems described herein may alternatively be configured to be automatically actuated. Further, the battery cycling systems of the present disclosure may be incorporated as part of a larger test and observation system, such as a larger battery cell cycling test system. The battery cycling systems may also be incorporated into a final commercial product or device in any suitable manner.

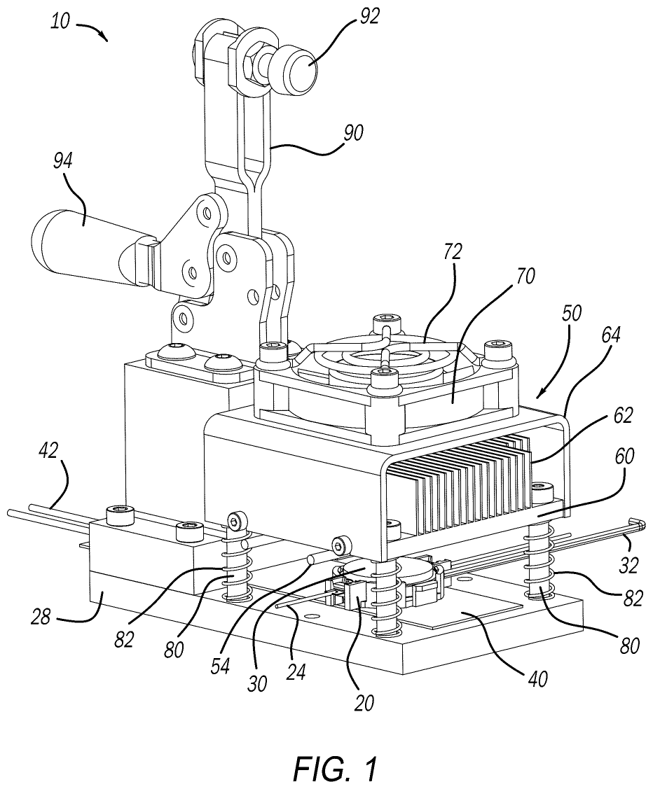

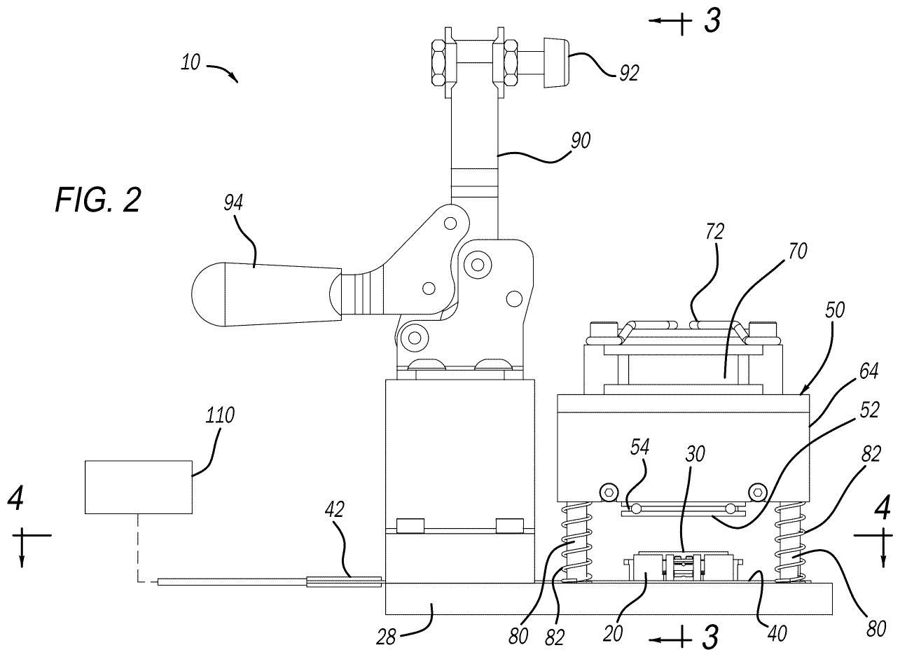

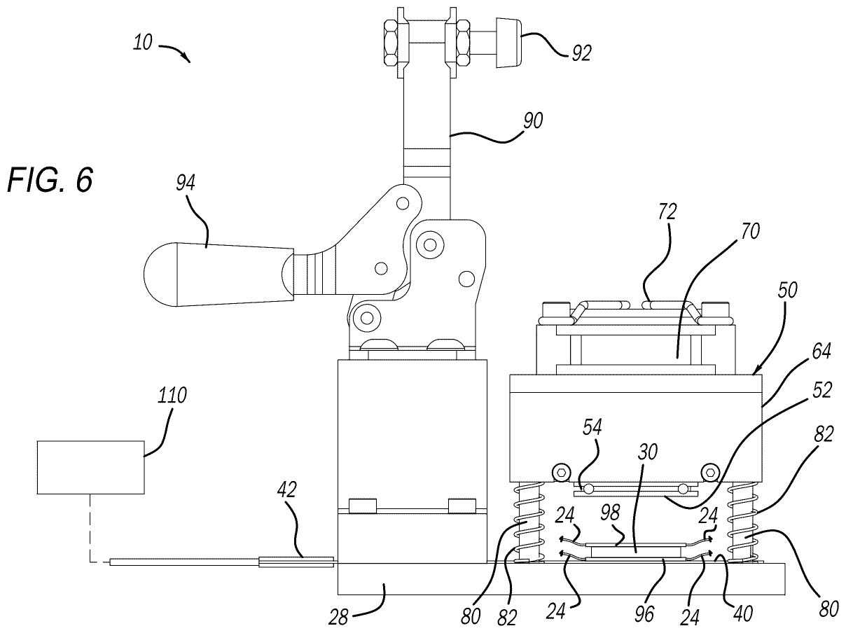

FIGS. 1-5 illustrate an exemplary battery cycling system 10 in accordance with the present disclosure. The battery cycling system 10 includes a battery holder 20 configured to hold a battery cell 30. The battery cell 30 may be configured as any suitable battery cell to be tested. In the example illustrated, the battery cell 30 is configured as a coin cell. The battery cell 30 may alternatively be configured as a pouch cell, a prismatic cell, etc. The battery cell 30 may be configured for any suitable automotive or non-automotive use. For example, the battery cell 30 may be configured to power a motor of any suitable fully electric vehicle, hybrid vehicle, etc. The battery holder 20 is optional and need not be included in all applications, such as in the example of FIG. 6 described herein.

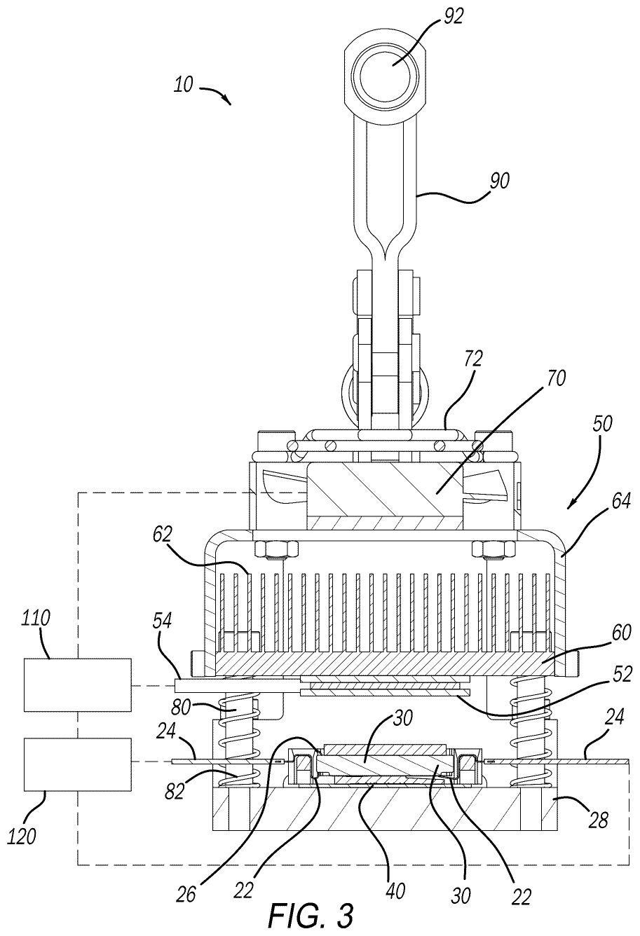

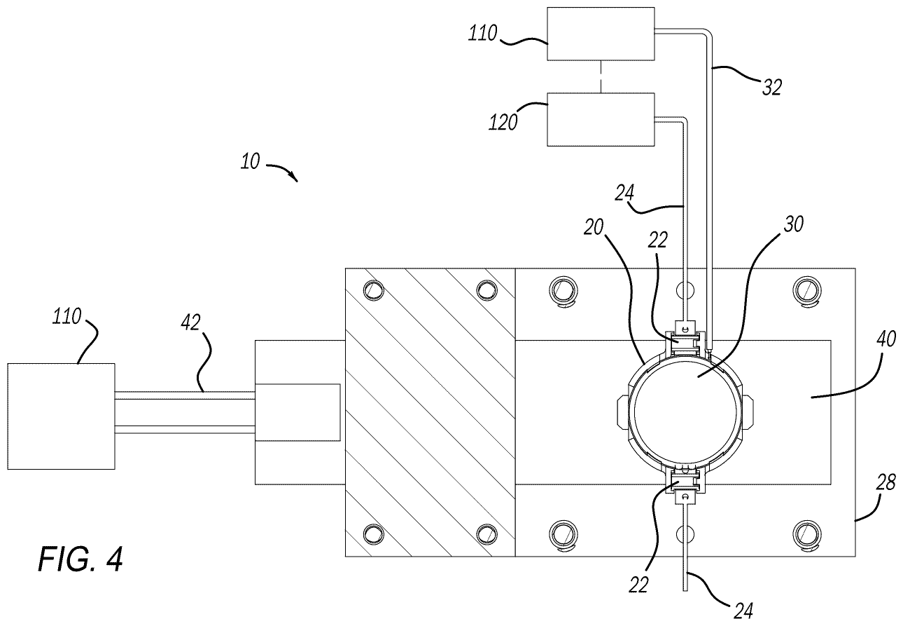

With particular reference to FIG. 3, the battery holder 20 includes contacts 22 configured to cooperate with lead lines 24. In the example illustrated, the battery holder 20 defines a receptacle 26, which is configured to receive the battery cell 30. The lead lines 24 are connected to a cycler 120, which may be any suitable cycling device configured to charge and discharge the battery cell 30. Operation of the cycler 120 is controlled by any suitable control module or controller 110. With reference to FIG. 4, any suitable temperature sensor may be included to monitor temperature of the battery cell 30. The temperature sensor may be configured as a thermocouple 32, for example, extending from the battery cell 30 to the controller 110. The controller 110 reads the temperature inputs from the thermocouple 32 and controls the heating (by way of heating device 40) and cooling (by way of cooling assembly 50) of the battery cell 30 based on the temperature readings.

The battery cycling system 10 further includes a heating device 40. The heating device 40 may be any suitable device configured to heat the battery cell 30 during cycling of the battery cell 30. For example, the heating device 40 may be any suitable resistance heater. The heating device 40 may be arranged at any suitable location. In the example illustrated, the heating device 40 is arranged below the battery holder 20. The battery cycling system 10 includes a base 28 on which the heating device 40 is seated. Lead lines 42 extend from the heating device 40 to the controller 110 and/or any suitable current source for supplying current to the heating device 40 to heat the heating device 40. The controller 110 is configured to operate the heating device 40, such as based on inputs received from the thermocouple 32, for example. The heating device 40 may be in direct contact with the battery cell 30, in direct contact with the battery holder 20, or arranged and configured in any other suitable manner to transfer heat to the battery cell 30.

The battery cycling system 10 also includes a cooling assembly 50. The cooling assembly 50 generally includes a cooling device 52, a heat sink 60, and a cooling fan 70. The cooling assembly 50 may also include any suitable liquid cooling device in place of, or in addition to, at least one of the heat sink 60 and the cooling fan 70. The cooling device 52 may be any suitable cooling device, such as any suitable thermoelectric cooling device. The cooling device 52 may be any suitable Peltier cooling device, for example. Leads 54 extend from the cooling device 52 to any suitable current source for powering the cooling device 52. The controller 110 is in communication with the cooling device 52 to control the cooling device 52. The cooling device 52 may also be powered by way of the controller 110. The controller 110 is configured to change the cooling rate of the cooling device 52 based on the temperature of the battery cell 30 as measured by the thermocouple 32.

In the example illustrated, the cooling device 52 is mounted to an undersurface of the heat sink 60. The heat sink 60 thus provides a base for the cooling device 52 to be mounted to. The cooling device 52 may be attached to an underside of the heat sink 60 with thermal paste, for example, to facilitate efficient heat transfer. Extending from a side of the heat sink 60 opposite to the cooling device 52 are fins 62, which facilitate heat dissipation. The fins 62 and the heat sink 60 generally are arranged within a housing 64. Opposite to the heat sink 60 is a cooling fan 70. The cooling fan 70 may be mounted to the housing 64, for example. The cooling fan 70 is connected to the controller 110 in any suitable manner to permit operation of the cooling fan 70 to be controlled by the controller 110. A cover 72 is arranged over the cooling fan 70. The cover 72 may be any suitable mesh or wireframe cover, for example. The heat sink 60 and the cooling fan 70 are optional. Thus, in some applications the battery cycling system 10 may include the cooling device 52 without the heat sink 60 and/or without the cooling fan 70. In such applications, the heat sink 60 and/or cooling fan 70 may be replaced with any other suitable heat removal device/method. For example, any suitable liquid cooler may be included.

The cooling device 52 is mounted in any suitable manner to permit the cooling device 52 to be movable between an inactive position in which the cooling device 52 is spaced apart from the battery cell 30, and an active position in which the cooling device 52 is in direct physical contact with the battery cell 30 to cool the battery cell 30. In the example illustrated, the cooling device 52 is mounted to the undersurface of the heat sink 60. The heat sink 60 is mounted over the base 28 by supports 80, which may be configured as posts. The supports 80 are rigidly mounted to the base 28. The supports 80 extend through openings defined within the heat sink 60. The supports 80 are not rigidly mounted to the heat sink 60 so as to allow the heat sink 60, and the cooling device 52 mounted thereto, to move vertically along the supports 80 to and away from the battery holder 20 and the battery cell 30 seated therein. The base 28 thus provides a common base for each one of the battery holder 20, the heating device 40, the cooling device 52, and the actuator 90.

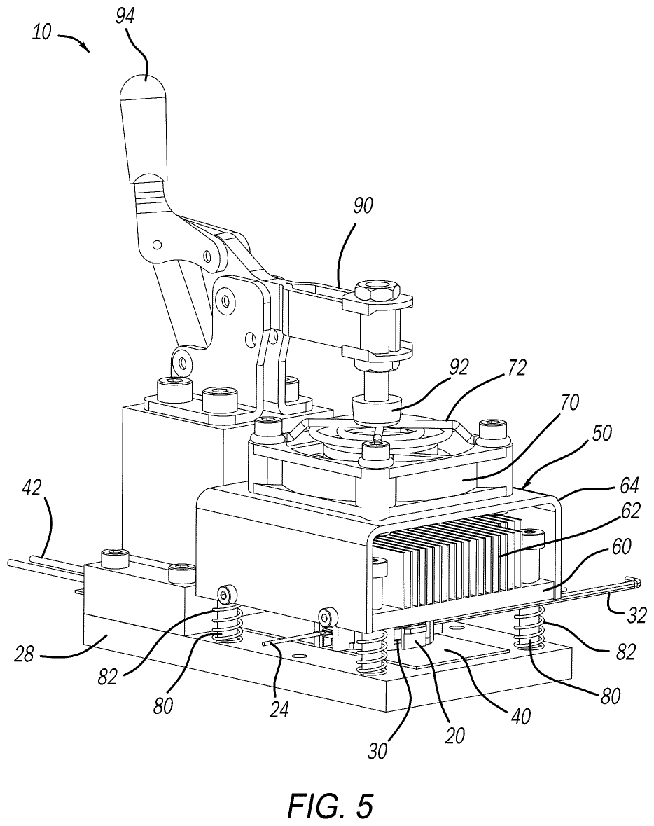

FIGS. 1-3 illustrate the cooling assembly 50 (and the cooling device 52 included therewith) in an inactive position, which is a raised position in which the cooling device 52 is spaced apart from the battery cell 30 and the battery holder 20. FIG. 5 illustrates the cooling assembly 50 (and the cooling device 52 included therewith) in an active position. In the active position the cooling device 52 is in direct physical contact with the battery cell 30 to cool the battery cell 30. The contact between the cooling device 52 and the battery cell 30 is ceramic and non-electrically conductive so as to eliminate any possibility of shorting the battery cell 30. The cooling assembly 50 is biased in the upward position by any suitable biasing members 82, which may take the form of springs, for example.

The cooling device 52 may be moved from the inactive position to the active position in any suitable manner. In the example illustrated, the battery cycling system 10 includes an actuator 90 for moving the cooling device 52. The actuator 90 generally includes a pusher 92 and a handle 94. The handle 94 may be manually operated, or movable in any suitable automated manner. In automated applications, the handle 94 may be eliminated, and vertical up and down motion may be provided in any suitable automated manner, such as with a pneumatic or electronic actuator, for example.

Actuation of the handle 94 moves the pusher 92 into cooperation with the cooling assembly 50 and pushes the cooling assembly 50 down to the active position of FIG. 5. More specifically, actuation of the handle 94 moves the pusher 92 down into cooperation with the cover 72 and presses the cooling assembly 50 downward such that the heat sink 60 slides down along the supports 80, which compresses the biasing members 82 and moves the cooling device 52 into direct physical contact with the battery cell 30 to cool the battery cell 30 while the battery cell 30 is being charged or discharged by the cycler 120. After the battery cell 30 has been cooled to a desired temperature and/or cooled for a desired amount of time, the handle 94 is moved in an opposite direction to separate the pusher 92 from the cover 72. With the pusher 92 separated from the cover 72 (and the cooling assembly 50 generally), the cooling assembly 50 moves upward from the active position of FIG. 5 to the inactive position of FIG. 1. More specifically, the biasing members 82 are configured to push the heat sink 60 upward, which separates the cooling device 52 from the battery cell 30 and the battery holder 20 to no longer cool the battery cell 30.

FIG. 6 illustrates the battery cycling system 10 configured without the battery holder 20. In the example of FIG. 6, the battery cell 30 is seated between a lower conductor 96 and an upper conductor 98. The lower conductor 96 and the upper conductor 98 may be any suitable electrical conductors. For example, the lower conductor 96 may be a lower copper foil seated on the heating device 40 and connected to lead lines 24. The battery cell 30 is seated on the lower copper foil. The upper conductor 98 may be an upper copper foil seated on the battery cell 30 and connected to lead lines 24. As described above, the lead lines 24 are connected to the cycler 120 for cycling the battery cell 30. The heating device 40 and the cooling device 52 are non-conductive. This configuration allows for more direct contact between the battery cell 30 and each of the heating device 40 and the cooling device 52.

The battery cycling system 10 is configured to apply heat-cool pulses (HCP) to the battery cell 30 during charging and/or discharging of the battery cell 30 by the cycler 120. Pulses of heat are applied by activating the heating device 40. Cooling pulses are applied by activating the cooling device 52 and moving the cooling device 52 into direct physical contact with the battery cell 30, such as by actuating the handle 94 to press the cooling assembly 50 and the cooling device 52 thereof downward to the active position of FIG. 5. The cooling device 52 is configured to enable cooling rates of, for example, 40° C./min and reach temperatures as low as 3.5° C. (and in some applications as low as 0 ° C. or nearly 0 ° C.). The cooling time takes about 2% of the charging sweep time (1° C. rate).

The battery cycling system 10 facilities, for example, observation of thermal electrochemical reactions taking place in the battery cell 30 during charging and discharging. The battery cycling system 10 provides temperature profile stabilization for fast-charging battery cycling experiments. The ability to observe electrochemical reactions of battery cells during charging and discharging is useful during battery cell research, design, and development, for example. Thermochemical responses of various battery material combinations may be observed using the battery cycling system 10 of the present disclosure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A battery cycling system comprising:
a base configured to support a battery cell in cooperation with lead lines for cycling the battery cell;
a heating device configured to heat the battery cell during cycling of the battery cell;
a cooling device configured to cool the battery cell during cycling of the battery cell, the cooling device movable between an inactive position in which the cooling device is spaced apart from the battery cell and an active position in which the cooling device is in contact with the battery cell to cool the battery cell; and
an actuator configured to move the cooling device from the inactive position to the active position to cool the battery cell during cycling of the battery cell.

2. The battery cycling system of claim 1, wherein the battery cell is one of a coin cell, a pouch cell, and a prismatic cell.

3. The battery cycling system of claim 1, further comprising a battery holder configured to hold the battery cell,
wherein the heating device includes a resistance heater beneath the battery holder.

4. The battery cycling system of claim 1, wherein the cooling device includes a thermoelectric cooling device.

5. The battery cycling system of claim 1, wherein the cooling device includes a Peltier cooling device attached to a heat sink with a thermal paste.

6. The battery cycling system of claim 1, wherein the cooling device includes a thermoelectric cooler and at least one of a fan, a heat sink, and a liquid cooling device.

7. The battery cycling system of claim 1, wherein the cooling device is included with a cooling assembly supported over the base, the cooling assembly movable to and away from the base and the battery cell seated on the base, the cooling assembly further including a fan and a heat sink.

8. The battery cycling system of claim 7, wherein the cooling assembly including the cooling device is biased in the inactive position, which is a raised position.

9. The battery cycling system of claim 8, wherein the actuator includes a lever movable to press the cooling assembly down onto the battery cell and press a thermoelectric cooler of the cooling device into direct physical contact with the battery cell.

10. The battery cycling system of claim 9, wherein the lever is configured to be hand-operated.

11. The battery cycling system of claim 1, further comprising a temperature sensor configured to sense temperature of the battery cell during cycling of the battery cell.

12. The battery cycling system of claim 11, further comprising:
a battery cycler configured to run the battery cell through charge cycles and discharge cycles; and
a controller configured to operate the heating device and the cooling device to heat and cool the battery cell during the charge cycles and the discharge cycles based on inputs from the temperature sensor.

13. The battery cycling system of claim 1, wherein each one of the heating device, the cooling device, and the actuator is mounted directly to or indirectly to the base.

14. A battery cycling system comprising:
a battery holder configured to hold a battery cell, the battery holder including contacts configured to cooperate with lead lines for cycling the battery cell;
a resistance heater beneath the battery holder configured to heat the battery cell seated in the battery holder during cycling of the battery cell;
a cooling assembly including a thermoelectric cooler, a fan, and a heat sink, the cooling assembly mounted over the battery holder and movable between an active position and an inactive position; and
an actuator configured to move the cooling assembly from an inactive position in which the thermoelectric cooler is spaced apart from the battery cell and an active position in which the thermoelectric cooler is in direct contact with the battery cell to cool the battery cell during cycling of the battery cell.

15. The battery cycling system of claim 14, wherein the actuator includes a lever movable to press the cooling assembly down onto the battery holder and press the thermoelectric cooler into direct physical contact with the battery cell.

16. The battery cycling system of claim 14, further comprising a temperature sensor configured to sense temperature of the battery cell during cycling of the battery cell.

17. The battery cycling system of claim 14, further comprising:
a battery cycler configured to run the battery cell through charge cycles and discharge cycles; and
a controller configured to operate the resistance heater and the cooling assembly to heat and cool the battery cell during the charge cycles and the discharge cycles.

18. A battery cycling method comprising:
charging a battery cell in contact with electrical conductors for cycling the battery cell;
discharging the battery cell;
during at least one of the charging and the discharging of the battery cell, heating the battery cell with a heating device; and
during at least one of the charging and the discharging of the battery cell, moving a cooling assembly from an inactive position in which a thermoelectric cooler of the cooling assembly is spaced apart from the battery cell to an active position in which the thermoelectric cooler is in direct physical contact with the battery cell to cool the battery cell, the cooling assembly further including a fan and a heat sink.

19. The battery cycling method of claim 18, wherein moving the cooling assembly includes moving a lever to press the cooling assembly down and press the thermoelectric cooler into direct physical contact with the battery cell.

20. The battery cycling method of claim 18, wherein the battery cell is one of a coin cell, a pouch cell, and a prismatic cell.
